(19) United States
(12) Patent Application Publication
(10) Pub. No.: US 2005/0077430 A1
(43) Pub. Date: Apr. 14, 2005

(54) Construction materials and methods for parafoils and parachutes

(75) Inventor: Daniel Preston, Kew Gardens, NY (US)

Correspondence Address: Brian P. Hopkins, Esq.;Mintz, Levin, Cohn, Ferris, Glovsky & Popeo, P.C., The Chrysler Center, 666 Third Avenue, 24th Floor, New York, NY, 10017, US

(73) Assignee: Atair Aerospace, Inc.

(21) Appl. No.: 10/875,653

(22) Filed: Jun. 23, 2004

Related U.S. Application Data
(60) Provisional application No. 60/480,997, filed on Jun. 23, 2003.
(60) Provisional application No. 60/482,142, filed on Jun. 24, 2003.

(51) Int. Cl. B64D 17/02

(52) U.S. Cl. 244/145

(57) ABSTRACT

A parachute is formed from a non-woven composite material. The non-woven composite material is formed by fusing a plurality of mono-filament fibers between thin layers of plastic. The fibers are positioned in directions within the material according to the stresses on the panels of the parachute. The panels of the parachute may be joined using fusing, adhesives or other non-sewing methods. The material may also be formed to have a three dimensional shape for each panel.

### PRIORITY

This application claims priority under 35 U.S.C. §1.119(e) from U.S. provisional patent application Nos. 60/480,997, filed Jun. 23, 2003, and 60/482,142, filed Jun. 24, 2003, each entire disclosure of which is herein incorporated by reference.

### BACKGROUND OF THE INVENTION

1. Field of the Invention

The present invention relates to construction of parafoils and parachutes. More particularly, it relates to use of a composite, non-woven material in parafoils and parachutes and methods of construction using such material.

2. Background

Parachutes, both decelerator type and ram-air, gliding wing type, are typically constructed from rip-stop nylon fabric. Rip-stop nylon is a square woven fabric, with the warp and weft fibers being positioned at 90 degrees to each other. The material is then typically treated with a silicone based chemical and calanderized to fill in the pores of the fabric to reduce its porosity and control air flow through the fabric. The treatment causes the fabric to become slick and non-stick.

The material as used in parachutes, must have various qualities, such as:
good tear strength (even after many hours exposed to Ultra Violet rays (UV);
low permeability to keep the cells pressurized;
light weight for better inflation; and
reduced packing volume.

Rip-stop nylon has advantages in weight, tear strength and longevity. The chemical make up of coatings and how they are applied to the fabric also affect the qualities of the final product.

Parachutes are designed to have a specific form during flight and is constructed from various panels which are shaped and put together to achieve the desired form. However, during flight, the fabric is subjected to complex mechanical and aerodynamics stresses which stress the fabric along the direction of its laid fibers, and in various patterns at a bias to the weave. As such, the actual shape of the assembled panels and the resulting inflated structure during flight, distort away from the desired modeled shape.

To combat this problem, the construction of a parafoil or parachute generally includes heavy narrow woven fabric tapes (or webbing) that is stitched into the structure to restrain the fabric panels into a shape closer to that modeled. However, the inclusion of reinforcing tape in the design adds packing volume and construction complexity.

Other problems with woven fabric reinforcing tapes include: inherent stretchability in various directions (the degree of stretch depends on the fiber, type of weave, and the directions of the stresses) shrinking from exposure to water and abrasion from absorbed particles and mildew.

The construction of parafoils and parachutes with rip-stop nylon panels and reinforcing tapes is also subject to construction tolerance errors by the nature of the sewing construction process. Specifically, due to the slick coating material, and the low tolerances in the design of parachute, highly skilled workers are required to construct a parachute. Even with highly skilled labor, the parachute is subject to inaccuracies during construction. For example, since the seams are tensioned by the sewing process and shrink, the accuracy of the constructed shape with respect to the design is limited.

For example, a common seam in a parachute involves three overlaying fabric panel edges plus a reinforcing tape. The reinforcing tape is rolled over and stitched over the entire length with a double needle lockstitch. It is extremely difficult to hold tolerances of several millimeters on match marks during this sewing process. Moreover, accumulative errors along a span of an average personnel parachute can amount to several inches. Thus, even before additional distortions are created due to stresses on the fabric, the parachute shape may vary from the design.

It is also difficult to test parachute designs or to obtain accurate data relating to parachute performance during flight, such as pressure distributions, air flows, and material shape, movement and stress. Obtaining such information has been attempted using wind tunnels. However, only two wind tunnels exist in the United States which are large enough for small to medium sized parachutes. Also, wind tunnels cannot provide accurate information regarding actual flights. The conditions in an wind tunnel are perfect and constant and do not necessarily reflect conditions during flight.

### SUMMARY OF THE INVENTION

Embodiments of the present invention address the concerns with the prior art as indicated above, as well as addressing other concerns which will become more evident upon the reading of the detailed description which follows, as well as the drawing which are included with the present application.

Accordingly, in a first embodiment of the present invention, a parachute or parafoil may include a canopy which may comprise a plurality of panels. At least one of the panels is manufactured of a laminated material having a lower plastic film, an upper plastic film and a plurality of mono-filaments positioned there-between.

In another embodiment of the invention, a panel for parachute or parafoil is provides and may include a laminated material having a lower plastic film, an upper plastic film and a plurality of mono-filaments positioned there-between.

In yet another embodiment of the present invention, a method of construction of a panel of a parachute or parafoil is presented, which may include the steps of laying down a first thin sheet, laying a plurality of mono-filaments on the first thin sheet, laying a second thin sheet over the plurality of mono-filaments, fusing the first thin sheet, plurality of mono-filaments and second thin sheet to form a laminate and cutting the panel of the parachute from the laminate.

The step of laying the plurality of mono-filaments may include the step of laying the mono-filaments in a plurality of directions corresponding to directions of expected stresses on the panel.

Moreover, the above method may also include cutting a plurality of panels from the laminate and assembling the panels to create a parachute or parafoil.

In still yet another embodiment of the present invention, a parachute may include a canopy comprising a plurality of panels. The plurality of panels may include a plurality of ribs, where each rib is manufactured of a laminated material having a lower plastic film, an upper plastic film and a plurality of mono-filaments positioned there-between.

The parachute according to claim 1, wherein the plurality of mono-filaments includes a first plurality of filaments positioned in a first direction, a second plurality of filaments positioned in a second direction different from the first direction and a third plurality of filaments positioned in a third direction different from the first and second directions.

The plurality of mono-filaments in any of the above embodiments may be positioned in a plurality of directions corresponding to directions of stresses in a particular panel in the canopy parachute.

The plurality of mono-filaments in any of the above embodiments may include a first plurality of filaments positioned in a first direction, a second plurality of filaments positioned in a second direction different from the first direction and a third plurality of filaments positioned in a third direction different from the first and second directions.

These and other embodiments, objects and advantages of the invention will become more clearer with reference to the attached drawings and following detailed description.

### BRIEF DESCRIPTION OF THE DRAWINGS

FIGS. 1A and 1B illustrate stresses on a rib of a ram air parachute.

FIG. 2 illustrates the stresses on a bottom skin of a ram air parachute.

FIG. 3 illustrates the stresses on a top skin of a ram air parachute.

FIGS. 4A-4D illustrate stresses on a top skin of a ram air parachute during opening.

FIGS. 5A and 5B illustrate the stresses on a round parachute.

FIGS. 6A-6E illustrate the resulting shapes in flight of various rib constructions due to stress.

FIG. 7 is an exploded view of a composite material according to an embodiment of the present invention.

FIGS. 8A-8D is illustrates a fiber pattern for a rib of a parachute.

### DETAILED DESCRIPTION

Parachutes are subjected to many stresses during operation. The stresses vary depending upon the part of the parachute and its current operation. Nevertheless, they must be constructed of a thin, lightweight material so that they can be packed and easily transported. A parachute must also be non-porous in order to present the best aerodynamic properties. Woven, rip-stop nylon, the typical material used for parachutes, meets the requirements of being thin and lightweight, but is porous and easily stretches. However, treatments used to reduce porosity may hinder fabrication. Moreover, reinforcing tapes must be used to control stresses and maintain a desired shape. However, the reinforcing tapes also stretch and make construction more complicated.

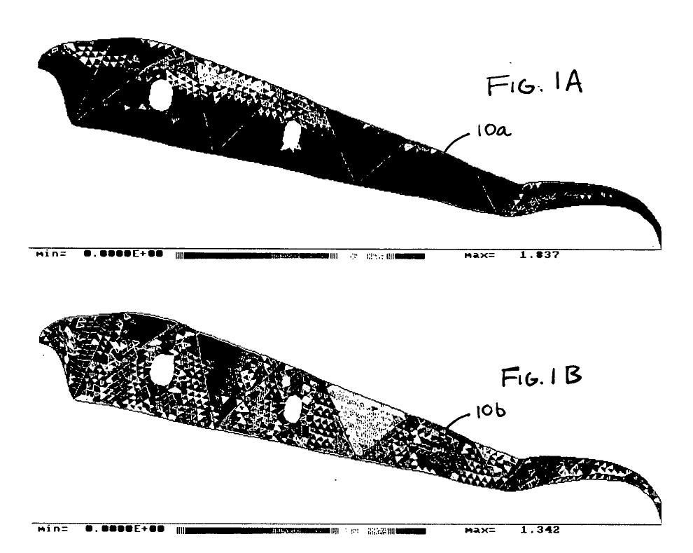

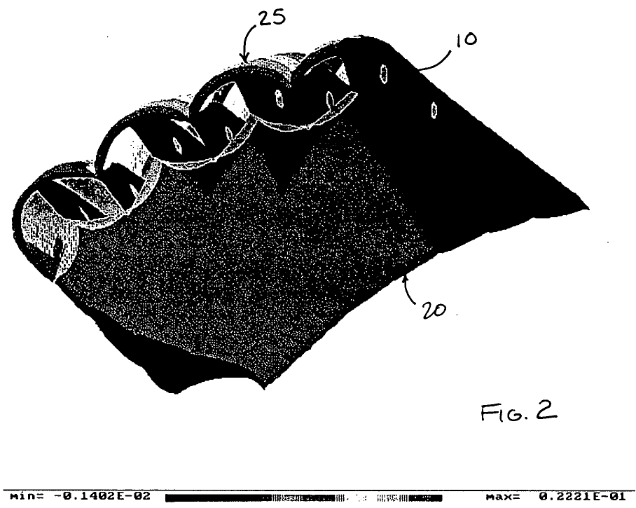

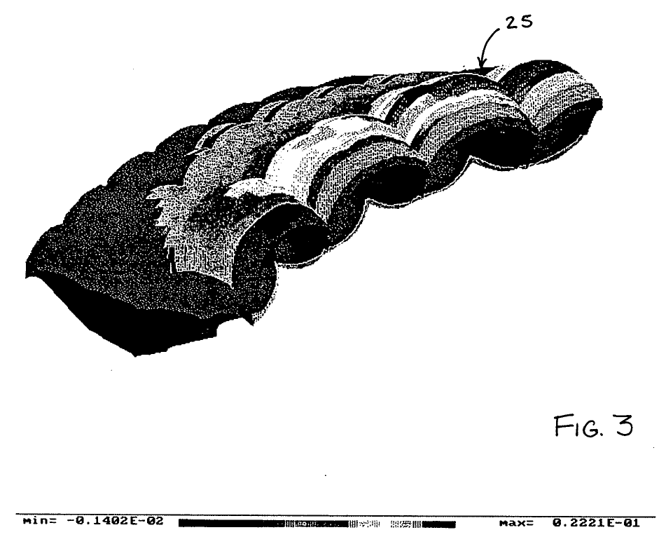

FIGS. 1A-5B illustrate stresses on the parachute during operation. FIGS. 1A and 1B represent the stresses on a standard ram-air parachute rib 10a, 10b during flight. The two figures show the stresses in the horizontal (FIG. 1A) and vertical (FIG. 1B) directions. FIG. 2 illustrates the stresses on ram-air parachute, principally the bottom skin 20. A ram air parachute, includes a top skin 25, a bottom skin 20 and a plurality of ribs 10 between the top and bottom skin. FIG. 3 illustrates the stresses on the top skin 25 of the ram air parachute.

As can be seen from FIGS. 1A, 1B, 2 and 3, the stresses on the parachute vary significantly from part to part and within a single part. The stresses on the ribs 10 are more complicated than for the top skin 25 or bottom skin 20. The stresses on the bottom skin 20 are fairly uniform and not very high. On the other hand, the stresses on the top skin 25 are concentrated at the forward portion 35 of the parachute.

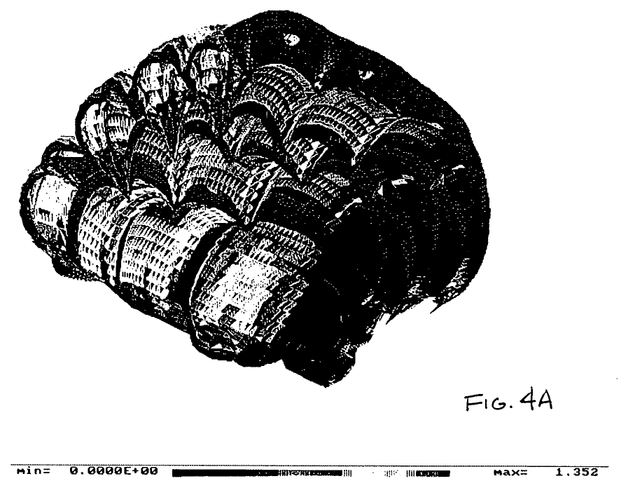

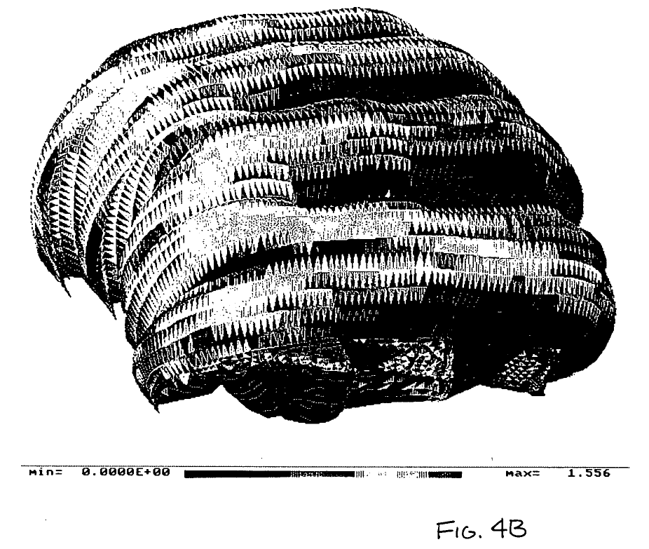

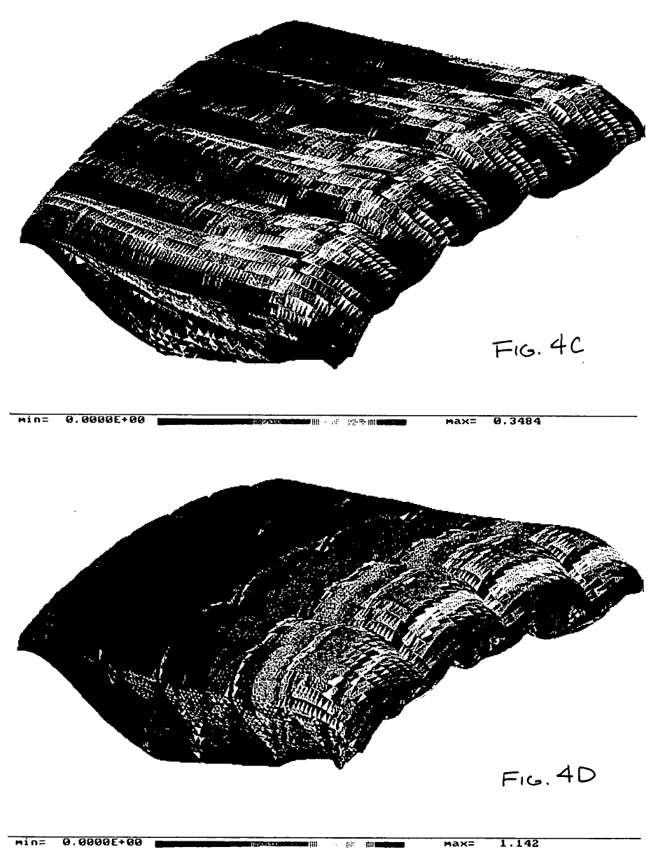

FIGS. 4A-4D illustrate the stresses on the parachute during deployment. FIG. 4A illustrates the parachute starting to open. FIG. 4B illustrates the parachute when partially open. FIGS. 4C and 4D represent orthogonal stresses on the parachute when almost fully open. As can be seen in these figures, the stresses vary significantly in strength and location during the deployment process.

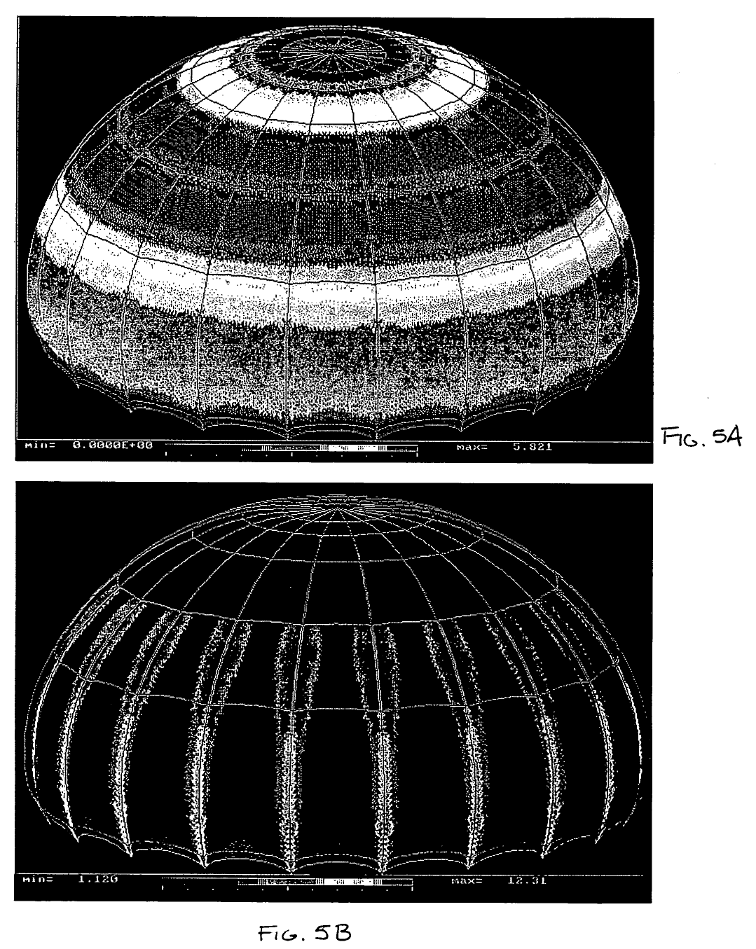

FIGS. 5A and 5B illustrate stresses in a round parachute in the vertical and horizontal, respectively. In the vertical direction (FIG. 5A), the stresses vary from the edge to the center of the parachute, with very high stresses a circular region 50 spaced from the apex. In the horizontal direction, the stresses are centered on the seams where the shrouds are attached and mostly towards the edge of the parachute.

Accordingly, despite large variations in stress patterns, current parachute and parafoil designs are constructed using a single type of woven fabric, with fibers at 90° angles to each other. To address some of the stresses, for example, parachute parts are currently formed in a shape (i.e., cut from the woven material) to best handle the stresses along the directions of the fibers. Nevertheless, the stresses still result in distortions in shape of the parachute.

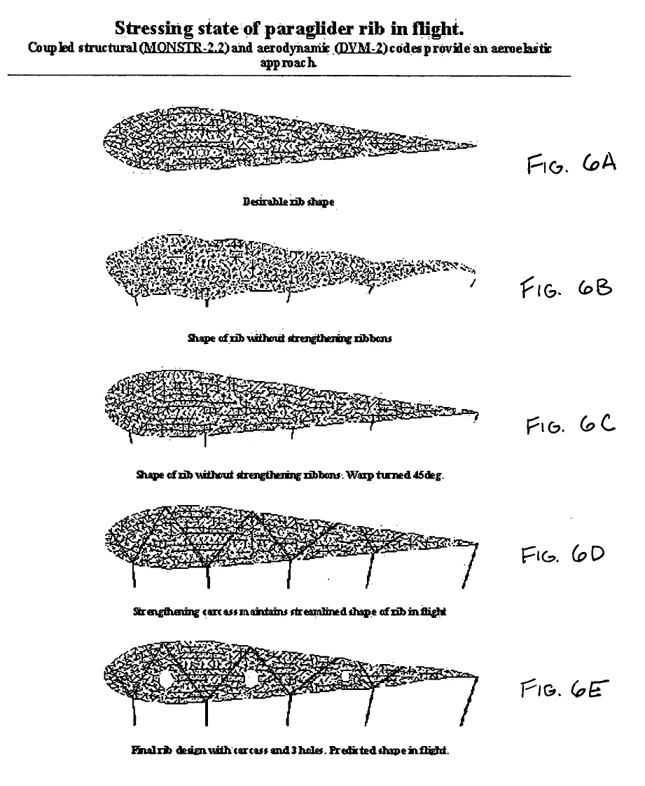

This is particularly a problem since a parachute is designed to have a specific shape for flight though the air. Distortions in shape greatly affect the flight characteristics of the parachute. For example, FIGS. 6A-E illustrate the shape distortions on a parachute rib. FIG. 6A represents the desired rib shape. FIG. 6B represents the shape of an unreinforced rib during flight of the parachute, which differs significantly from the desired shape shown in FIG. 6A.

To address some of the stresses, as mentioned earlier, one or more parachute panels may be cut in a certain way from the woven fabric. Accordingly, FIG. 6C illustrates the shape of an unreinforced rib cut so that the warp is 45° to the cord of the rib. This results in an improvement in shape, but some distortions still remain around the shroud attachment points. The addition of reinforcing tapes 15 in a triangular pattern, as illustrated in FIG. 6D, help correct some of the remaining distortions. Finally, FIG. 6E illustrates a final shape of a rib with reinforcing tape and cross port holes. While the shape is close to the desired shape, the use of reinforcing tapes increases the weight and pack volume of the parachute. It also creates additional possibilities of construction errors which will allow shape distortion.

Accordingly, the problems with stresses and shape may be handled, according to some embodiments of the invention, through construction of the parachute with one or more panels and/or ribs manufactured from a flexible composite fabric. Such a composite material, for example, may be a formed, laminated sheet of plastic and high strength fibers.

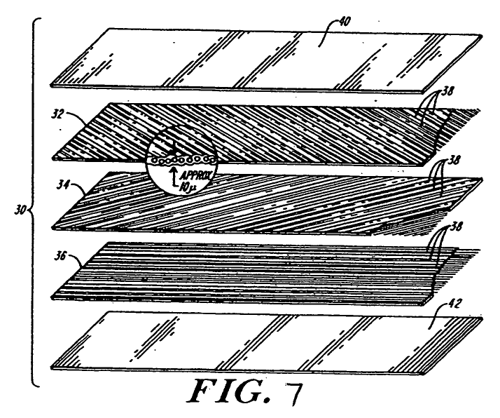

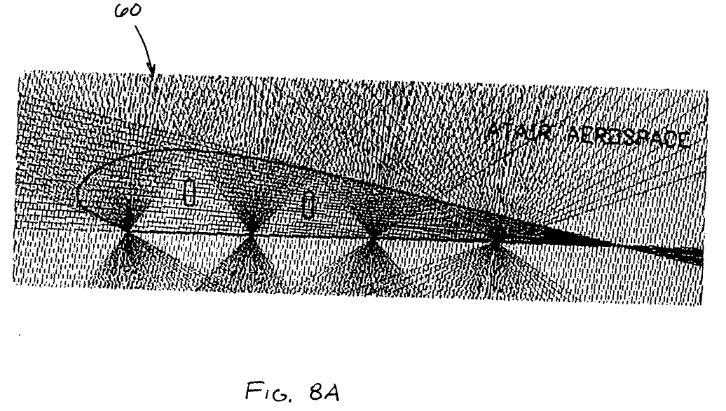

In that regard, FIG. 7 illustrates, in an exploded view, the construction of one such synthetic material/fabric 30 used in some of the embodiments of the present invention. As shown, fibers 38 of a high strength material are laid, in layers 32, 34, 36 (forming, for example, unidirectional “uni-tapes” 32, 34 and 36), on an extremely thin sheet of plastic 42. The plastic material may be a polyethylene or polyester film, mylar, or other material with similar properties, for example. The fibers 38 may be of spectra, Kevlar, HMA, carbon fiber or other high strength material. A second sheet of plastic 40 is placed on top of the fibers. The entire structure is fused using heat and pressure. Such a material is described in U.S. Pat. No. 5,333,568 entitled Material for the Fabrication of Sails and U.S. Pat. No. 5,470,632 entitled Composite Material for Fabrication of Sails and Other Articles, both incorporated herein in their entirety by reference.

The material 30 may include a preferable approximate thickness of 10 microns, but may be between 5 microns and 100 microns thick. Each uni-tape may preferably be provided with 50 to 85 percent monofilaments by volume, with the monofilaments being provided, for example, with a carrier of bonding resin which forms a matrix that includes monofilaments and resin. Each of the uni-tapes 32, 34 and 36 may include Monofilaments 38 which extend from one edge of the completed uni-tape to the other in a single direction. According to some preferable embodiments, the uni-tapes may be placed in different directions in each layer so that the fibers are positioned along different paths. For each direction that the monofilaments are placed in, the resulting material is stronger. The uni-tapes 32, 34, 36 may also be placed parallel along an entire layer of the material. Uni-tapes with different widths and numbers of fibers may also be used in different directions.

In some embodiments of the invention, the specific pattern for placement of the uni-tapes depends upon the particular panel of the parachute to be cut out from the fabric. Preferably, the pattern is selected to provide strength and minimize stretch along the directions of stresses of the panel, and generally is not uniform across the entire sheet of material.

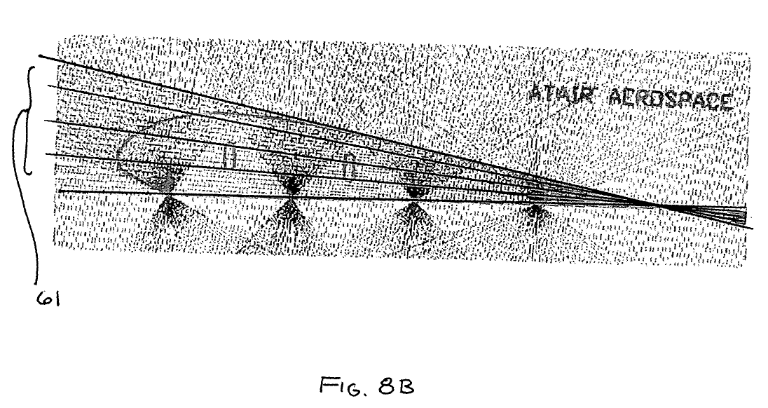

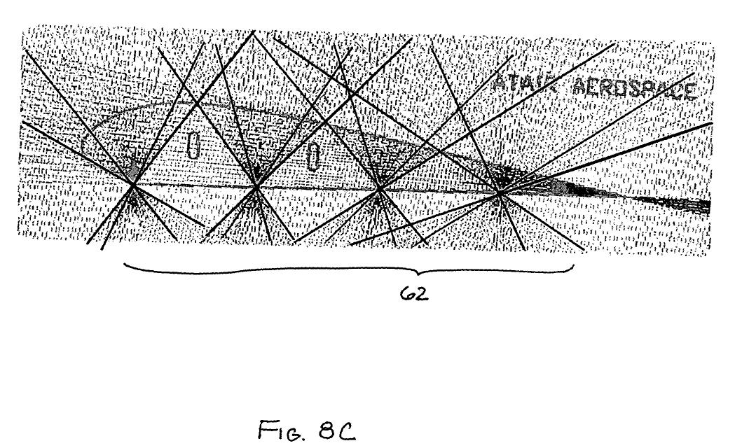

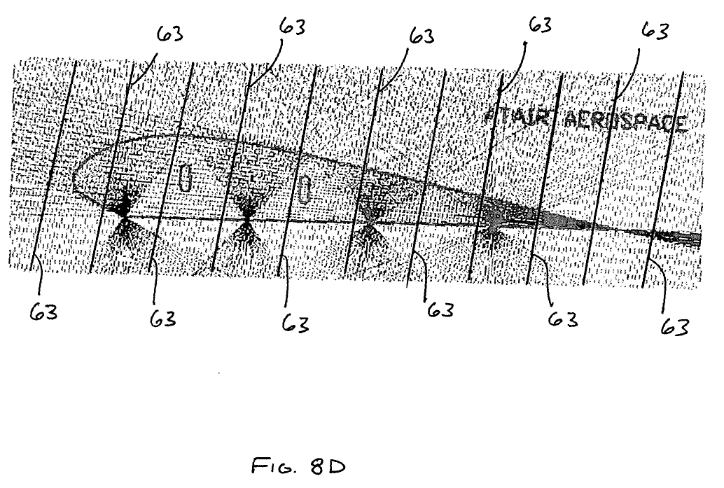

To that end, FIGS. 8A-8D illustrate an exemplary pattern for placement of uni-tapes in construction of material 60 for a rib 70 of a parachute/parafoil. FIG. 8A illustrates lines which correspond to directions of stresses in a parachute/parafoil rib. FIGS. 8B-8D represent these various stress lines:

FIG. 8B illustrates a few of the stress lines 61 which lie in a direction corresponding to the length of the rib;

FIG. 8C illustrates a few of the stress lines 62 which correspond to the stress areas of the attachment lines which connect to the rib; and

FIG. 8D illustrate a few of the stress lines 63 which correspond to a height-wise direction of the rib.

Each group of lines 61, 62, 63, according to some embodiments of the invention, thus represents a direction for placement of a uni-tape, for example, and a direction that the monofilament fibers in the composite material may be arranged. In some embodiments, areas of higher stress may include more fibers positioned along the direction of the stresses, as well as areas of lower stress which may have fewer fibers (which also may simply be placed at 45° angles).

The fabric sheet constructed as in FIG. 7 and set forth above is a nonwoven flexible composite fabric which is considerably lighter, thinner and stronger than ripstop nylon. Additionally, the strength and resistance to stretch is designed into the fabric through the orientation of the high strength fibers to match the exact orientation of how it will be stressed. Multiple layers of the fibers can be used to create areas having different stress characteristics within a single panel. This is a major advantage for critical areas of the parachute: by laying the fiber reinforcement to match the actual stress pattern, additional reinforcing webbing can be eliminated, reducing the volume and/or weight of the parachute. Thus, the composite material according to some embodiments of the present invention ensures the highest strength and lowest volume for the parachute. Additionally as the composite material has, in some embodiments, little to no “crimp”, even simple material with the fibers not laid in a specific orientation to the induced stress (e.g., 2 layers of fibers, 90 deg. to each other), has been shown in tests to out perform (and in some cases, substantially outperform) ripstop nylon, with the added benefit of being (in some embodiments) up to 68% lighter (or more), up to or greater than 300% stronger and up to 8 times or more lower stretch at the breaking point.

Other advantages of the above process may also result in fabric panels that are inherently zero porosity, without additional chemical treatments required for ripstop nylon. Moreover, the composite fabric allows alternate joining techniques for forming parachutes: multiple panels can be fused using a variety of methods, which may include the use of, for example, jig tooling. Panels can be joined by using ultrasonic welding or chemical bonding, i.e. adhesives or adhesive transfer tapes. Such construction techniques may result in joined seams that do not introduce tension and dimensional errors as does sewing. Additionally, such seams require a lower degree of skill for the assembly worker (technical sewing requires a high degree of skill and not many seamstresses can become proficient enough to construct parachutes and parafoils with accuracy). The chemical bonding of panels is a simple assembly technique that can be taught to most anyone. The resulting chemical bonds are extremely strong and in many cases can exceed the strength of the fabric. The resulting seams are thin and low bulk compared to sewn seams.

Additionally, the composite fabric of the present invention can be constructed with a three-dimensional shape. The use of a laminate allows the shape to be created during the fabrication process using, for example molds and other fabrication techniques. For example, a domed sheet can be fabricated with a suitable fiber pattern to be used as a round decelerator parachute. Typically, a parachute is formed of a plurality of panels sewn together to achieve the desired three-dimensional shape. By forming all or some of the panels in a three dimensional shape during construction, fewer seams are required and the strength of the parachute is improved.

The use of the composite material in parachutes and parafoils in the present invention allows improved experimentation with fibers for parachute uses. For example, the woven webbing tapes used on parachutes are typically produced on extremely high volume machines, and the industry has not been able to make use of major developments of stronger lighter fibers because it can not justify the expense of large minimum setup runs. However, with the laminated fiber approach, according to embodiments of the present invention, small batch runs may be produced, which are economical and allow new fibers or mixtures of new fibers, for example, and experimentation to take place. Additionally multiple fiber types can be mixed and fiber direction controlled in ways not possible with woven fabrics. Please carry over this paragraph to the other application.

Furthermore, embodiments of the present invention using a laminated composite construction makes it possible to integrate wires, circuitry and sensors into the structure of the parachute itself. For example, fiber optic strain gauges, solor cells, antennas, wires and small electronic circuitry and sensors can be laid into the laminate and fused in during formation of the material.

Alternatively, since bonding is possible with the material, gauges, wires, circuitry or sensors can be bonded to the material after formation. The integration of devices, either within the laminate or bonded to it, allows for improved testing, research and development. Complex measurements of pressure distribution, flow, and stresses can be obtained during flight for review of parachute performance. Additionally, miniature video and vibration analyses of parafoils and parachutes during flight are possible.

The integration of devices also allows creation of smart parachutes which can aid users. Integrated sensors could more quickly determine if a parachute deployed properly or malfunctioned than with sensors mounted on the jumper or cargo. This is a huge benefit for low altitude drops where immediate reaction is required. Also, the parachute could contain a simple integrated circuit that would self diagnose the condition of a parachute from a number of jumps to determine if any portion has been over stressed or damaged such that repair or replacement is required.

Having now described a few embodiments of the invention, it should be apparent to those skilled in the art that the foregoing is merely illustrative and not limiting, having been presented by way of example only. Numerous modifications and other embodiments are within the scope of ordinary skill in the art and are contemplated as falling within the scope of the invention.

1. A parachute comprising:
a canopy comprising a plurality of panels, wherein at least one of the panels is manufactured of a laminated material having a lower plastic film, an upper plastic film and a plurality of mono-filaments positioned there-between.

2. The parachute according to claim 1, wherein each panel of the canopy is manufactured of the laminated material.

3. The parachute according to claim 1, wherein the plurality of mono-filaments includes a first plurality of filaments positioned in a first direction, a second plurality of filaments positioned in a second direction different from the first direction

4. The parachute according to claim 1, wherein the plurality of mono-filaments includes a first plurality of filaments positioned in a first direction, a second plurality of filaments positioned in a second direction different from the first direction and a third plurality of filaments positioned in a third direction different from the first and second directions.

5. The parachute according to claim 1, wherein the plurality of mono-filaments are positioned in a plurality of directions corresponding to directions of stresses in a particular panel in the canopy parachute.

6. The parachute according to claim 1, wherein the plurality of panels includes at least one rib, and wherein at least one of the at least one rib comprises the laminated material.

7. The parachute according to claim 6, wherein the plurality of mono-filaments includes a first plurality of filaments positioned in a first direction, a second plurality of filaments positioned in a second direction different from the first direction and a third plurality of filaments positioned in a third direction different from the first and second directions.

8. The parachute according to claim 6, wherein the plurality of mono-filaments are positioned in a plurality of directions corresponding to directions of stresses in a particular panel in the canopy parachute.

9. The parachute according to claim 1, wherein at least one of the panels made of the laminate includes one or more electrical devices and/or wires for communicating electrical signals.

10. The parachute according to claim 9, wherein the electrical devices comprise a sensor.

11. A panel for parachute or parafoil comprising a laminated material having a lower plastic film, an upper plastic film and a plurality of mono-filaments positioned there-between.

12. The panel according to claim 11, wherein the plurality of mono-filaments are positioned in a plurality of directions corresponding to directions of stresses in a particular panel in the canopy parachute.

13. A parachute comprising:
a canopy comprising a plurality of panels, wherein the plurality of panels includes a plurality of ribs, wherein each rib is manufactured of a laminated material having a lower plastic film, an upper plastic film and a plurality of mono-filaments positioned there-between.

14. The parachute according to claim 13, wherein the plurality of mono-filaments are positioned in a plurality of directions corresponding to directions of stresses in the parachute.

15. A method of construction of a panel of a parachute, the method comprising the steps of:
laying down a first thin sheet;
laying a plurality of mono-filaments on the first thin sheet;
laying a second thin sheet over the plurality of mono-filaments;
fusing the first thin sheet, plurality of mono-filaments and second thin sheet to form a laminate; and
cutting the panel of the parachute from the laminate.

16. The method according to claim 15, wherein the step of laying the plurality of mono-filaments includes the step of laying the mono-filaments in a plurality of directions corresponding to directions of expected stresses on the panel.

17. The method according to claim 15, further comprising cutting a plurality of panels from the laminate and assembling the panels to create a parachute or parafoil.

18. A method of construction of a panel of a parachute, the method comprising the steps of:
cutting a plurality of panels having a predetermined shape for assembly into a parachute canopy from a sheet of fiber reinforced plastic film;
assembling the plurality of panels into the parachute canopy; and
fusing the plurality of panels together.

19. The method according to claim 18, wherein fusing comprises using at least one of an adhesive and ultrasonic fusing.
